(19) United States
(12) Patent Application Publication
(10) Pub. No.: US 2013/0196123 A1
(43) Pub. Date: Aug. 1, 2013

(54) Method for marking polymer compositions containing graphite nanoplatelets

(71) Applicants: Joseph E. Sarver, Erial, NJ (US); Marc Mamak, Mason, OH (US); Urs Leo Stadler, Madison, NJ (US)

(72) Inventors: Joseph E. Sarver, Erial, NJ (US); Marc Mamak, Mason, OH (US); Urs Leo Stadler, Madison, NJ (US)

(73) Assignee: BASF SE, Ludwigshafen (DE)

(21) Appl. No.: 13/634,650

(22) PCT Filed: Mar. 14, 2011
(86) PCT No.: PCT/US2011/028293

§ 371 Date: Oct. 17, 2012

Related U.S. Application Data
(60) Provisional application No. 61/314,415, filed on Mar. 16, 2010.

(51) Int. Cl. B05D 3/06

(52) U.S. Cl. CPC B05D 3/06
USPC 428/195.1; 427/555

(57) ABSTRACT

Polymer substrates are marked by a method in which certain graphite nanoplatelets are incorporated into the polymer composition, such as a coating or plastic article, prior to marking the composition by exposing selected portions of the substrate to a heat source, typically a laser. Additional pigments may also be present allowing for the production of a variety of different types of markings.

A method for marking a polymeric substrate is disclosed, which method comprises incorporating certain graphite nanoplatelets into a polymer composition, such as a coating or plastic article, prior to exposure of selected portions of the substrate to a heat source, typically a laser. The graphite nanoplatelets can act as a black pigment which becomes lighter at the point of heat exposure or a laser energy-absorbing additive, which increases the efficiency of other laser marking protocols.

### BACKGROUND

Laser marking is a well known and important means for quickly and cleanly inscribing plastic surfaces with identification marks, such as date codes, batch codes, bar codes or part numbers, functional marks, such as computer keyboard characters, and decorative marks, such as company logos. “Laser marking” can also be applied as a somewhat generic term to markings produced by methods wherein an alternate source of thermal radiation, for example, an electrode diode array, is used in place of a laser. The most common laser marks are either a dark mark on a lighter colored background or a light mark on a dark colored background. However, laser markings of different colors and the production of UV detectable laser marks are also known and receive significant interest.

A light or a colored mark on a dark background may also be produced when a dark colored additive, such as carbon black or a dark color pigment, is combined with a resin and exposed to a laser resulting in the vaporization or bleaching of the additive exposing the natural polymer color or an underlying heat-stable color pigment. A dark marking can be formed by the use of additives that are colorless but change into a visible dark or black product when subjected to laser irradiation.

U.S. Pat. No. 4,861,620, incorporated herein in its entirety by reference, discloses pigments that undergo an irreversible or semi-irreversible change of internal structure and hence color due to a temperature increase by laser irradiation. The pigments may be incorporated into a plastic material or coated onto the surface of a substrate prior to marking. For Example, the color changing pigment may be incorporated in a lacquer which is applied to the substrate surface.

U.S. Pat. No. 6,022,905, incorporated herein in its entirety by reference, discloses a laser-marked plastic article comprising at least two differently colored laser marks obtained by exposing to various laser energies a thermoplastic composition comprising a laser energy absorbing additive and color pigments capable of changing to more than one color depending on the amount of applied heat.

Color marks have been formed on a dark background by a Nd:YAG laser or a frequency doubled Nd:YAG laser (wavelength 532 nm), on, for example, a polyacetal copolymer resin or a polybutylene terephthalate resin containing a mineral black pigment (bone charcoal, bone black or ivory black) that is removed or destroyed by the laser, and a heat-stable organic and/or inorganic pigment or a polymer-soluble dye. Color marks have also been achieved with a Nd:YAG laser on thermoplastics that have been colored by an organic dye or pigment and an inorganic pigment of the same color, and which also contain carbon black. These color marks have the same color as the background color of the plastic, but have a lighter tone.

U.S. Pat. No. 7,544,448 and co-pending U.S. application Ser. No. 11/978,764, incorporated herein in their entirety by reference, disclose methods for forming laser markings that are not visible under ordinary conditions but are visible when viewed under UV light. These fluorescent markings are produced by the conversion of non-fluorescent pigments into fluorescent dyes of the same chemical composition, presumably by the dissolution into the polymer matrix, and are useful, for example, in security markings, product codes, part codes and shipping codes.

Typically, laser marking is due to the rapid production of heat in the irradiated portion of the plastic due to the absorption of energy leading to a physical change detectable by the eye under appropriate conditions. The change may be due to the change in a colorant or some change in the polymer itself. Some thermoplastics, such as polyethylene, polypropylene and polystyrene, are transparent to laser energy at certain wavelengths and the efficiency of laser marking can be increased by including in the resin composition a laser energy-absorbing additive, such as carbon black, graphite, kaolin, mica, and the like, that increases the rate of temperature rise in the localized portion of the polymer exposed to the laser. A dark marking on polyethylene containing an energy absorbing pigment can be produced at a relatively low energy level (3 joules/cm²) by heat-induced carbonization of the polymer and/or the pigment.

While some polymers, such as polycarbonate, ABS and polystyrene, have a tendency to carbonize when subjected to heat caused by laser irradiation, other polymers, such as many polyolefins including high density polyethylene, have little tendency to carbonize, but will show a light mark caused by foaming of the resin due to the heat produced by the laser.

As mentioned above, carbon black can be used in laser marking either as a laser absorbing additive or a pigment which can be bleached. U.S. Pat. No. 5,262,470 discloses the use of graphite particle with an average diameter of 0.1-150 microns as a laser sensitive pigment in polyester compositions; DE 102007002786 discloses laser marking of plastics containing diphenyl cresyl phosphate and expanded graphite.

Polymer composites of nano-scaled graphite are known and have a variety of desirable characteristics, for example unusual electronic properties and/or strength. Graphene sheets, one-atom thick two-dimensional layers of carbon, as well as carbon nanotubes have been studied and sought after for some time. Likewise, nano-scaled graphite, or graphite nanoplatelets have been studied as an alternative to graphene sheets or carbon nanotubes.

For example, U.S. Pat. No. 6,395,199 discloses a process for increasing electrical and/or thermal conductivity of a material by applying particles of expanded graphite to a substrate; U.S. 2004/0217332 discloses electrically conductive compositions composed of thermoplastic polymers and expanded graphite; U.S. Patent Pub. No. 2007/0284557 provides transparent and conductive films produced using commercially available graphene flakes.

Stankovich, et al., in Nature, Vol. 442, July, 2006, pp. 282-286, teaches polystyrene-graphene composites. The graphene is prepared by treating graphite oxide with phenyl isocyanate. The isocyanate functionalized graphite oxide is exfoliated by ultrasonication in DMF. Polystyrene is added to the resulting dispersion in DMF. The dispersed material is reduced with dimethylhydrazine. Coagulation of the polymer composite is accomplished by adding the DMF solution to a large volume of methanol. The coagulated composite is isolated and crushed to a powder.

U.S. Pat. No. 6,872,330 provides nanomaterials prepared by intercalating ions into layered compounds, exfoliating to create individual layers and then sonicating to produce nanotubes, nanosheets, etc. For instance, carbon nanomaterials are prepared by heating graphite in the presence of potassium to form a first stage intercalated graphite. Exfoliation in ethanol creates a dispersion of carbon sheets. Upon sonication carbon nanotubes are prepared. The graphite may be intercalated with alkali, alkali earth or lanthanide metals.

U.S. Pat. No. 7,071,258 provides a process for preparing graphene plate from a partially or fully carbonized precursor polymer or by heat treating petroleum or coal tar pitch to produce a polymeric carbon comprising graphite crystallites containing sheets of graphite plane followed by exfoliation and mechanical attrition.

U.S. Patent Pub. Nos. 2006/0241237 and 2004/0127621 teach the expansion of intercalated graphite by microwaves or radiofrequency waves. U.S. Pat. No. 6,287,694 is aimed at a method for preparing expanded graphite.

U.S. Pat. Nos. 5,776,372 and 6,024,900 teach carbon composites comprising an expanded graphite and a thermoplastic or thermosetting resin; U.S. 2008/0149363 discloses compositions comprising a polyolefin and an expanded graphite. Specifically disclosed are conductive formulations for cable components; WO 2008/045778 is aimed at graphene rubber nanocomposites.

The U.S. patents and patent publications listed herein are incorporated by reference.

Co-pending U.S. application Ser. No. 12/380,365, incorporated herein by reference, discloses graphite nanoplatelets prepared by thermal plasma expansion of intercalated graphite followed by exfoliation, and polymers, coatings, inks, lubricants and greases containing the graphite nanoplatelets. The graphite nanoplatelets are particularly effective, even at very low levels, in imparting a high level of thermal and electrical conductivity to the substrates into which they are incorporated.

It is found that graphite nanoplatelets can greatly improve the efficiency of laser marking methods when added to a polymer composition either as an energy absorbing additive or as a pigment which is bleached on exposure to laser radiation.

### SUMMARY OF THE INVENTION

A method is provided for producing markings on a polymer composition, with great precision and efficiency, by incorporating graphite nanoplatelets into the polymer composition and then exposing a selected portion the polymer composition to a heat source, for example laser radiation or diode array. Other colorants may be present in the formulation. The markings produced may be due to changes in these other colorants which is made more efficient by the presence of the graphite nanoplatelets; the markings may be the result of bleaching of the graphite nanoplatelets; or the marks may be due to physical changes to the polymer itself which changes are made more efficient by the presence of the graphite nanoplatelets. Thus, while laser active materials other than the graphite nanoparticles may be present, in some embodiments they are not. The markings produced may be visible under ambient light or may only be detectable under special conditions such as luminescent markings visible only under UV light.

### DETAILED DESCRIPTION OF THE INVENTION

A method for marking a polymer composition, for example an article or coating comprising a thermoplastic, thermoset, crosslinked or inherently crosslinked polymer, which method comprises incorporating into said polymer graphite nanoplatelets and in a later step exposing a selected portion of the polymer composition to heat, for example a diode array or laser irradiation, to produce markings which are visible under ambient light or UV light.

The graphite nanoplatelets of the method generally have a thickness of about 50 nm or less, for example, from about 0.34 nm to about 50 nm, and a length and width of about 50 microns or less, for example, from about 500 nm to about 50 microns with a specific density of from about 0.01 to about 0.006 g/cc, for example, 0.03 to about 0.001 g/cc and the BET surface area is typically greater than about 30 m²/g, for example from about 60 to about 600 m²/g, for example from about 70 to about 150 m²/g. The aspect ratio of the nanoplatelets is at least 50 and may be as high as 50,000. That is 95% of the particles have this aspect ratio. For instance, the aspect ratio of 95% of the particles is from about 500 to about 10,000, for instance from about 600 to about 8000, or from about 800 to about 6000.

The present graphite nanoplatelets may consist of hexagonal and rhombohedral polymorphs. The present graphite nanoplatelets for example may consist of a hexagonal polymorph with a 002 peak residing between 3.34 angstroms to 3.4 angstrom, as observed in a powder X ray diffraction pattern. The C:O mol ratio (carbon:oxygen) ratio of the graphite nanoplatelets is typically greater than 50, for example, the C:O ratio is from about 50 to 200, for instance from about 50 to about 100.

For example, the process of U.S. application Ser. No. 12/380,365, which provides graphite nanoplatelets where greater than 95% of the graphite nanoplatelets generally have a thickness of about 50 nm or less, for example, from about 0.34 nm to about 50 nm, and a length and width of about 50 microns or less, for example, from about 500 nm to about 50 microns, and in many cases greater than 90% of the nanoplatelets have a thickness of from about 3 nm to about 20 nm and a width of from about 1 micron to about 30 microns, is an excellent source for the graphite nanoplatelets of the invention.

The polymer of the polymer composition is a thermoplastic, thermoset, crosslinked or inherently crosslinked polymer and may be, for example, in the form of a film, sheet, molded article, extruded workpiece, laminate, felt, or part of a coating composition etc, and the composition will typically contain other commonly encountered additives at typical concentrations including other pigments and dyes.

In one particular embodiment, the polymer composition is a coating or film, for example a coating or film adhered to the surface of an organic or inorganic substrate.

In certain embodiments of the invention, the polymer composition containing the graphite nanoplatelets also contains a pigment or dye other than the graphite nanoplatelets, such as an organic pigment or dye. In such circumstances, several approaches may be taken resulting in a different type of marking, wherein different amounts of the graphite nanoplatelets may be employed.

For example, a polymer composition containing a heat-stable organic and/or inorganic pigment and the graphite nanoplatelets may contain enough of the graphite nanoplatelets so that the presence of the nanoplatelets imparts color to the composition. Exposure to the heat source, typically a laser, can cause the graphite nanoplatelets to bleach at the point of irradiation and a marking will be produced which is the color of the heat-stable pigment. The color contrast of the marking relative to its surroundings can be significant, especially if enough of the graphite nanoplatelets are present to overwhelm the color imparted to the polymer by the heat stable pigment, or a more subtle color difference can be obtained if the graphite nanoplatelets are present in a lower concentration which only imparts a small tinting effect to the pigmented polymer.

In another example of the invention, a less thermally stable colorant is chosen. The markings produced may then result from the degradation of the colorant. In this embodiment, it is also possible to use a low enough concentration of the graphite nanoplatelets so that the color of the polymer composition is not affected by the presence of the nanoplatelets, but high enough to act as a laser energy-absorbing additive increasing the rate of destruction of the less thermally stable colorant. The markings then will be due to the destruction of said colorant and can be a lighter shade of the original color, a clear marking if the colorant degrades to leave no residual color, or a different color if either the less thermally stable colorant degrades to a different colored material or if more thermally stable colorant is present, in which case the color will shift to reflect the color of the more thermally stable colorant.

In one particular embodiment, the nanoplatelets act as a laser energy-absorbing additive increasing the rate of conversion of an organic colorant into a fluorescent form of the same colorant, as in U.S. Pat. No. 7,544,448 and co-pending U.S. application Ser. No. 11/978,764, already incorporated by reference. The resulting marking may then be the same color as the unmarked portion of the polymer composition, but reveal a fluorescent mark when viewed under UV light.

Markings obviously can also be produced on polymer compositions containing the graphite nanoplatelets but no other colorant. For example, as discussed above, markings due to carbonization or foaming of a polymer when exposed to a heat source can be made on polymer compositions containing a low, non-coloring amount of the graphite nanoplatelets and light markings can be formed by the bleaching of the graphite nanoplatelets on compositions which are colored due to a higher concentration of the graphite nanoplatelets.

Of course any combination of the above effects can be obtained by varying the amounts of graphite nanoplatelets and the amounts and types of any additional colorants.

The graphite nanoplatelets of the invention offer significant advantages over, e.g., carbon black or graphite in laser marking. While each can function as a pigment and alternately as an energy absorbing additive, the present expanded and exfoliated graphite nanoplatelets are far more effective than carbon black or graphite when used either as an energy absorbing additive or pigment. Lower quantities of graphite nanoplatelets are needed to produce the desired effects and even at the lower concentrations less energy is needed, resulting in savings in both energy and time.

The graphite nanoplatelets are present in the laser markable polymer composition in an “effective amount”, that is an amount that provides both the desired level of pigmentation or coloration of the composition and which also lends itself to heat induced marking. As can be seen from the above discussion, a wide range of graphite nanoplatelet concentrations can be employed depending on the desired effect.

For example, when the markings produced by the method are due to the bleaching of color imparted to the substrate by the presence of the nanoplatelets the concentration must be high enough to create a discernable contrast between the bleached and non-bleached portions of the marked substrate. On the other hand, a lower concentration of the nanoplatelets can be used when the markings are due to the degradation of another colorant or the solvation of a pigment to generate a fluorescent marking.

The thickness of the polymer composition containing the graphite nanoplatelets also plays a role in determining the proper concentration as a thicker substrate comprising a composition containing the same concentration of graphite nanoplatelets will be darker than a thinner substrate of the same composition. For example, 100 nm films of neat graphite nanoparticles are nearly colorless as shown in U.S. Ser. No. 12/380,365, Example 13.

Thus, depending on the particular type of marking desired and the type of substrate and polymeric composition being marked, the graphite nanoplatelets may be present in as little as 0.01% by weight based on the weight of the polymeric composition containing them to as high as 35%. Concentrations as high as 35% will be in a thin section such as a coating, film or other thin layer applied to a thicker article.

Typically, the graphite nanoplatelets will be present in amounts of about 0.01% to about 15% by weight. In plastic sheets or other molded articles that are, for example, about 1 mm to several cm thick, the concentration of graphite nanoplatelets will typically be from about 0.01% to about 7%, for example 0.01 to about 5%. In coating layers, films or thin sections which are less than 1 mm thick, the concentration of graphite nanoplatelets will typically be from about 0.1% to about 15%, for example 0.1 to about 10%, for example, from about 0.1% to about 5%.

The polymer composition comprises a thermoplastic, thermoset, crosslinked or inherently crosslinked polymer, typical examples include polyolefins, polyamides, polyurethanes, polyacrylates, polyacrylamides, polycarbonates, polystyrenes, polyvinyl acetates, polyvinyl alcohols, polyesters, halogenated vinyl polymers such as PVC, alkyd resins, epoxy resins, natural or synthetic rubber such as polybutadiene, polyacrylates, polyacetals, poly polyketones, unsaturated polyesters, unsaturated polyamides, polyimides, fluorinated polymers, silicon containing polymers, carbamate polymers, copolymers, blends and composites thereof etc.

Commercial polymers useful in the invention include:

1. Polymers of mono- and di-olefins, for example polypropylene, polyisobutylene, polybutene-1, poly-4-methylpentene-1, polyisoprene or polybutadiene and also polymerisates of cyclo-olefins, for example of cyclopentene or norbornene; and also polyethylene (which may optionally be crosslinked), for example high density polyethylene (HDPE), high density polyethylene of high molecular weight (HDPE-HMW), high density polyethylene of ultra-high molecular weight (HDPE-UHMW), medium density polyethylene (MDPE), low density polyethylene (LDPE), and linear low density polyethylene (LLDPE), (VLDPE) and (ULDPE).

Polyolefins, that is to say polymers of mono-olefins, as mentioned by way of example in the preceding paragraph, especially polyethylene and polypropylene, can be prepared by various processes, especially by the following methods:

a) by free radical polymerisation (usually at high pressure and high temperature);

b) by means of a catalyst, the catalyst usually containing one or more metals of group IVb, Vb, VIb or VIII. Those metals generally have one or more ligands, such as oxides, halides, alcoholates, esters, ethers, amines, alkyls, alkenyls and/or aryls, which may be either π- or σ-coordinated. Such metal complexes may be free or fixed to carriers, for example to activated magnesium chloride, titanium(III) chloride, aluminium oxide or silicon oxide. Such catalysts may be soluble or insoluble in the polymerisation medium. The catalysts can be active as such in the polymerisation or further activators may be used, for example metal alkyls, metal hydrides, metal alkyl halides, metal alkyl oxides or metal alkyl oxanes, the metals being elements of group(s) Ia, IIa and/or IIIa. The activators may have been modified, for example, with further ester, ether, amine or silyl ether groups.

2. Mixtures of the polymers mentioned under 1), for example mixtures of poly-propylene with polyisobutylene, polypropylene with polyethylene (for example PP/HDPE, PP/LDPE) and mixtures of different types of polyethylene (for example LDPE/HDPE).

3. Copolymers of mono- and di-olefins with one another or with other vinyl monomers, for example ethylene/propylene copolymers, linear low density polyethylene (LLDPE) and mixtures thereof with low density polyethylene (LDPE), propylene/butene-1 copolymers, propylene/isobutylene copolymers, ethylene/butene-1 copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and copolymers thereof with carbon monoxide, or ethylene/acrylic acid copolymers and salts thereof (ionomers), and also terpolymers of ethylene with propylene and a diene, such as hexadiene, dicyclopentadiene or ethylidenenorbornene; and also mixtures of such copolymers with one another or with polymers mentioned under 1), for example polypropylene-ethylene/propylene copolymers, LDPE-ethylene/vinyl acetate copolymers, LDPE-ethylene/acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, for example polyamides.

4. Hydrocarbon resins (for example C₅-C₉) including hydrogenated modifications thereof (for example tackifier resins) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/acrylonitrile, styrene/alkyl methacrylate, styrene/butadiene/alkyl acrylate and methacrylate, styrene/maleic anhydride, styrene/acrylonitrile/methyl acrylate; high-impact-strength mixtures consisting of styrene copolymers and another polymer, for example a polyacrylate, a diene polymer or an ethylene/propylene/diene terpolymer; and also block copolymers of styrene, for example styrene/butadiene/styrene, styrene/isoprene/styrene, styrene/ethylene-butylene/styrene or styrene/ethylene-propylene/styrene.

7. Graft copolymers of styrene or α-methylstyrene, for example styrene on poly-butadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned under 6), such as those known, for example, as so-called ABS, MBS, ASA or AES polymers.

8. Halogen-containing polymers, for example polychloroprene, chlorinated rubber, chlorinated and brominated copolymer of isobutylene/isoprene (halobutyl rubber), chlorinated or chlorosulfonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate.

9. Polymers derived from α,β-unsaturated acids and derivatives thereof, such as polyacrylates and polymethacrylates, or polymethyl methacrylates, polyacrylamides and polyacrylonitriles impact-resistant-modified with butyl acrylate.

10. Copolymers of the monomers mentioned under 9) with one another or with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers.

11. Polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1.

12. Homo- and co-polymers of cyclic ethers, such as polyalkylene glycols, polyethylene oxide, polypropylene oxide or copolymers thereof with bisglycidyl ethers.

13. Polyacetals, such as polyoxymethylene, and also those polyoxymethylenes which contain comonomers, for example ethylene oxide; polyacetals modified with thermoplastic polyurethanes, acrylates or MBS.

14. Polyphenylene oxides and sulfides and mixtures thereof with styrene polymers or polyamides.

15. Polyurethanes derived from polyethers, polyesters and polybutadienes having terminal hydroxyl groups on the one hand and aliphatic or aromatic polyisocyanates on the other hand, and their initial products.

16. Polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; polyamides prepared from hexamethylenediamine and iso- and/or tere-phthalic acid and optionally an elastomer as modifier, for example poly-2,4,4-trimethylhexamethylene terephthalamide or poly-m-phenylene isophthalamide. Block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or ABS; and polyamides condensed during processing (“RIM polyamide systems”).

17. Polyureas, polyimides, polyamide imides, polyether imides, polyester imides, polyhydantoins and polybenzimidazoles.

18. Polyesters derived from dicarboxylic acids and dialcohols and/or from hydroxycarboxylic acids or the corresponding lactones, such as polyethylene terephthalate, polybutylene terephthalate, poly-1,4-dimethylolcyclohexane terephthalate, polyhydroxybenzoates, and also block polyether esters derived from polyethers with hydroxyl terminal groups; and also polyesters modified with poly-carbonates or MBS.

19. Polycarbonates and polyester carbonates.

20. Polysulfones, polyether sulfones and polyether ketones.

21. Crosslinked polymers derived from aldehydes on the one hand and phenols, urea or melamine on the other hand, such as phenol-formaldehyde, urea-formaldehyde and melamine-formaldehyde resins.

22. Drying and non-drying alkyd resins.

23. Unsaturated polyester resins derived from copolyesters of saturated and unsaturated dicarboxylic acids with polyhydric alcohols, and also vinyl compounds as crosslinking agents, and also the halogen-containing, difficultly combustible modifications thereof.

24. Crosslinkable acrylic resins derived from substituted acrylic esters, e.g. from epoxy acrylates, urethane acrylates or polyester acrylates.

25. Alkyd resins, polyester resins and acrylate resins that are crosslinked with melamine resins, urea resins, isocyanates, isocyanurates, polyisocyanates or epoxy resins.

26. Crosslinked epoxy resins derived from aliphatic, cycloaliphatic, heterocyclic or aromatic glycidyl compounds, e.g. products of bisphenol-A diglycidyl ethers, bisphenol-F diglycidyl ethers, that are crosslinked using customary hardeners, e.g. anhydrides or amines with or without accelerators.

27. Natural polymers, such as cellulose, natural rubber, gelatin, or polymer-homologously chemically modified derivatives thereof, such as cellulose acetates, propionates and butyrates, and the cellulose ethers, such as methyl cellulose; and also colophonium resins and derivatives.

28. Mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The polymer composition may also have incorporated therein other standard additives such as antioxidants, UV absorbers, hindered amine or other light stabilizers, phosphites or phosphonites, benzofuran-2-ones, thiosynergists, polyamide stabilizers, metal stearates, nucleating agents, fillers, reinforcing agents, lubricants, emulsifiers, dyes, pigments, dispersants, optical brighteners, flame retardants, antistatic agents, blowing agents and the like, other processing agents or mixtures thereof.

Due to the particular physical properties of graphite nanoplatelets, incorporation of the nanoplatelets into a polymer resin may benefit from special handling techniques as found in U.S. Ser. No. 12/380,365, however, once incorporated into the resin, any standard processing technique can be used in producing the final article.

For example, in certain situations, it may be possible to incorporate dry graphite nanoplatelets into a suitable substrate directly using standard means. Alternately, a wet filter cake of particles directly from production may be employed as is for incorporation into the appropriate substrate. The filter cake may also be dried and the nanoplatelets may be re-dispersed in an aqueous or organic solvent to prepare a solvent concentrate. The filter cake or solvent concentrate may advantageously contain residual surfactant.

It may be preferred in other situations to first prepare polymer concentrates or masterbatches of the graphite nanoplatelets by, for example, combining a wet filter cake or solvent concentrate of nanoparticles with a suitable polymer under melt conditions in a heatable container such as a kneader, mixer or extruder. Polymer concentrates may also be prepared by a flushing process, as disclosed for example in U.S. Pat. No. 3,668,172. For instance the graphite nanoplatelets are dispersed in water with the aid of a dispersant, a low molecular weight polyolefin or a similar wax is added and the mixture is subjected to stirring, heat and if necessary pressure to melt the polyolefin, whereupon the graphite is transferred from the aqueous phase into the polyolefin and cooled, filtered and dried. The loading of graphite nanoplatelets in the concentrates is for example from about 20 to about 60 weight percent based on the composition.

For addition to plastics, the filter cake, solvent concentrate or polymer concentrate may be melt blended with the polymer, for example in kneaders, mixers or extruders. Polymer films may be film cast from an organic solvent solution of polymer and filter cake or solvent concentrate. Polymer plaques may be compression molded from a mixture of polymer and filter cake or solvent concentrate or polymer concentrate. Subsequent processing of the nanoplatelet/polymer composition can be accomplished using standard process steps well known in the literature including extrusion, co extrusion, compression molding, Brabender melt processing, film formation, injection molding, blow molding, other molding and sheet forming processes, fiber formation, surface impregnation, suspension, dispersion etc.

In one embodiment, the carbon nanoplatelets are contained in a polymer layer which is co-extruded on a thicker polymeric article. Co-extrusion is a well known technique used in making multi-layered articles and is often employed to concentrate particular additives, such as UV absorbers, in a surface layer where they will be most effective.

In one embodiment, the polymer composition is a coating which has been applied to an article. The coating can comprise any coating system, for example, auto coatings, marine coatings, paints, inks, laminates, receiving layers for printing applications, or other protective or decorative coatings. The coating composition according to the invention can be applied to any desired substrate, for example to metal, wood, plastic, composite, glass or ceramic material substrates by the customary methods, for example by brushing, spraying, pouring, draw down, spin coating, dipping or electrophoresis; see also Ullmann's Encyclopedia of Industrial Chemistry, 5th Edition, Vol. A18, pp. 491-500.

The coating comprises a polymeric binder which can in principle be any binder customary in industry, for example those described in Ullmann's Encyclopedia of Industrial Chemistry, 5th Edition, Vol. A18, pp. 368-426, VCH, Weinheim 1991. In general, it is a film-forming binder based on a thermoplastic or thermosetting resin, predominantly on a thermosetting resin. Examples thereof are alkyd, acrylic, acrylamide, polyester, styrenic, phenolic, melamine, epoxy and polyurethane resins.

For example, non-limiting examples of common coating binders useful in the present invention include silicon containing polymers, fluorinated polymers, unsaturated polyesters, unsaturated polyamides, polyimides, crosslinkable acrylic resins derived from substituted acrylic esters, e.g. from epoxy acrylates, urethane acrylates, polyester acrylates, polymers of vinyl acetate, vinyl alcohol and vinyl amine. The coating binder polymers may be co-polymers, polymer blends or composites.

Coatings are frequently crosslinked with, for example, melamine resins, urea resins, isocyanates, isocyanurates, polyisocyanates, epoxy resins, anhydrides, poly acids and amines, with or without accelerators.

The binder can be a cold-curable or hot-curable binder and the addition of a curing catalyst may be advantageous. Suitable catalysts which accelerate curing of the binder are described, for example, in Ullmann's Encyclopedia of Industrial Chemistry, Vol. A18, p.469, VCH Verlagsgesellschaft, Weinheim 1991.

The binder may be a surface coating resin which dries in the air or hardens at room temperature. Exemplary of such binders are nitrocellulose, polyvinyl acetate, polyvinyl chloride, unsaturated polyester resins, polyacrylates, polyurethanes, epoxy resins, phenolic resins, and especially alkyd resins. The binder may also be a mixture of different surface coating resins. Provided the binders are curable binders, they are normally used together with a hardener and/or accelerator.

Acrylic, methacrylic and acrylamide polymers and co-polymers dispersible in water are readily used as a binder in the present invention. For example, acrylic, methacrylic and acrylamide dispersion polymers and co-polymers.

Obviously the coating composition can also comprise further components, examples being solvents, pigments, dyes, plasticizers, stabilizers, thixotropic agents, drying catalysts and/or levelling agents. Examples of possible components are those described in Ullmann's Encyclopedia of Industrial Chemistry, 5th Edition, Vol. A18, pp. 429-471, VCH, Weinheim 1991.

Possible drying catalysts or curing catalysts are, for example, organometallic compounds, amines, amino-containing resins and/or phosphines. Examples of organometallic compounds are metal carboxylates, metal chelates organotin compounds and the like.

The coating compositions can be radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the abovementioned publication Ullmann's Encyclopedia of Industrial Chemistry, 5th Edition, Vol. A18, pages 451-453. In radiation-curable coating compositions, the novel stabilizers can also be employed without the addition of sterically hindered amines.

The coating may also be a radiation-curable, solvent-free formulation of photopolymerisable compounds. Illustrative examples are mixtures of acrylates or methacrylates, unsaturated polyester/styrene mixtures or mixtures of other ethylenically unsaturated monomers or oligomers.

The coating compositions can comprise an organic solvent or solvent mixture in which the binder is soluble. The coating composition can otherwise be an aqueous solution or dispersion. The vehicle can also be a mixture of organic solvent and water. The coating composition may be a high-solids paint or can be solvent-free (e.g. a powder coating material). Powder coatings are, for example, those described in Ullmann's Encyclopedia of Industrial Chemistry, 5th Ed., A18, pages 438-444. The powder coating material may also have the form of a powder-slurry (dispersion of the powder preferably in water).

Multilayer coating systems are possible, where the nanoplatelets of the invention reside in a coating (or substrate) which is then coated with another coating, such as a protective coating.

The polymer composition of the invention can also be a preformed film. The film may be a stand alone film or may be applied to the surface of a substrate by, for example, the use of an adhesive, or co-extruded onto the surface. A film can be prepared for example, from the resin melt, by casting from a solution or by another method known in the art such as calendaring and shrink wrapping.

The heat source used to form the fluorescent species is typically a laser. It may be any laser that delivers radiation at wavelengths that are absorbed by the polymer composition in a manner which discreetly heats the selected portion of the substrate to leave the desired marking. For Example, lasers used to produce markings are found in U.S. Pat. No. 4,861,620; 6,022,905; 5,075,195; co pending U.S. Application No. 60/738,455, incorporated by reference, as well as European patent applications 0 036 680 and 0 190 997, and U.S. Pat. No. 4,307,047, which US Patent is hereby incorporated by reference. Such lasers are readily adaptable to the present invention. Other lasers useful in the invention are known and many are commercially available.

The marking can be any marking including letters, numbers, bar codes, geometric shapes and other figures including logos and other designs.

Methods for deflecting the laser beam through a mask or otherwise directed over the surface of the object to be marked, in conformity with the shape of the marking which is to be applied are likewise known and are useful in the present method.

In one embodiment of the invention, the polymer composition contains, along with the graphite nanoplatelets, a non fluorescing colorant which is transformed into a fluorescing species upon exposure to the laser or other heat source as in U.S. Pat. No. 7,544,448 and co-pending U.S. application Ser. No. 11/978,764. Such colorants are generally organic pigments which can be solubilzed in the polymer when exposed to high enough heat, for example, tetrabenzodiazadiketoperylene, quinacridone, diketopyrrolopyrrole, perylene indanthrone, anthroquinone, azo, isoindoline and phthalocyanine pigments, including mixed crystals and solid solutions, for example, the colorant is a tetrabenzodiazadiketoperylene, quinacridone, DPP or perylene pigment.

In such an embodiment, a marking can be made which is not visible under ambient viewing conditions, but patterns of selected colors are readily apparent when viewed under the appropriate ultra violet radiation. This is a useful feature, for example, in security marking applications. In the practice of this aspect of the invention it is desirable that the pigment which is transformed to a fluorescing species remain insoluble throughout the processing of the pigmented polymeric substrate to avoid unwanted fluorescence throughout the entire article. This allows for greater contrast between the laser marked and unmarked portions when exposed to ultra-violet light.

It is worthy of note that in addition to the colorant that undergoes conversion to the fluorescent form during the practice of this invention, colorants which do not undergo such a change may also be present. Also, more than one colorant that undergoes conversion to the fluorescent form during the practice of this invention may be present.

Obviously, one embodiment relates to the graphite sensitized bleaching of another pigment or dye.

When employing the graphite nanoplatelets in a composition containing other colorants, standard processing of the colorants at standard concentrations are known and used. Also, caveats related to the use of such colorants need to be observed, for example, when preparing a fluorescent marking similar to U.S. application Ser. No. 11/978,764, a coating or film in which the selected pigment is overly soluble will cause the system to fluoresce without heat exposure and is not typically appropriate.

Other embodiments of the invention include the laser marked composition obtained by the method and the use of select graphite nanoparticles in laser marking processes.

### EXAMPLES

### Example 1

A black paint containing 0.5% by weight of graphite nanoplatelets obtained as a dispersion in toluene/water according to Example 4 of U.S. application Ser. No. 12/380,365, is prepared by milling the nanoplatelets along with a mixture of 2.3 grams of toner of Tetrabenzodiazadiketoperylene, 1.2 grams of DISPERBYK 161, 16.9 grams of an acrylic mill base and 39.3 grams of a letdown with 100 grams of 2 mm glass beads in a SKANDEX mill following the procedure of Example 1 of U.S. Pat. No. 7,544,448. The resulting paint is separated from the beads.

A drawdown of the paint using a 100 micron wet film wired bar and a KCC automatic film applicator is prepared and dried over a white/black leneta card. The black coating over the white part of the card is marked using a laser. The black coating appears relatively unchanged under regular white light but under black light the mark fluoresces bright red.

### Example 2

A red paint containing 0.2% by weight of graphite nanoplatelets obtained as a dispersion in toluene/water according to Example 4 of U.S. application Ser. No. 12/380,365 is prepared by milling a mixture of a toner containing Pigment Red 202 (a quinacridone pigment), DISPERBYK 161, an acrylic mill base and a letdown is milled with 2 mm glass beads using a SKANDEX mill following the procedure of Example 1 above. The resulting paint is separated from the beads.

A drawdown of the paint using a 100 micron wet film wired bar and a KCC automatic film applicator is prepared and dried over a leneta card and marked with a laser. The red coating appears unchanged under ambient visible light, but under black light (UV light) the mark fluoresces bright yellow.

### Example 3

The procedure of Example 2 is repeated using a toner prepared with Pigment Red 283 (a DPP pigment), to provide a red coating which is laser marked. The red coating appears unchanged under ambient visible light, but under black light (UV light) the mark fluoresces a green shade of yellow.

### Example 4

A mixture of toner containing Pigment Red 283, graphite nanoplatelets obtained as dried filter cake produced by the method of Example 4 in U.S. application Ser. No. 12/380,365, POLANE G, (Polyurethane coating from The SHERWIN-WILLIAMS COMPANY) and 100 g of 2 mm glass beads is shaken for 2 hours using a SKANDEX mill. The resulting mill base is separated from the beads.

To the resulting mill base is added one third by weight of catalyst isocyanate followed by mixing. This paint is drawdown with a 3 mil bar over a leneta card. The coating is allowed to cure at room temperature overnight and is laser marked. The red coating appears unchanged under ambient visible light, but under black light (UV light) the mark fluoresces yellow.

### Example 5

The procedure of Example 3 is repeated using a toner prepared with MAGENTA PIGMENT RT 343 (a quinacridone pigment), to provide a red coating which is laser marked. The red coating appears unchanged under ambient visible light, but fluoresces strongly under black light.

### Example 6

In a 100 mL test tube, the following are added: a) 6 g of PARALOID B-66 thermoplastic acrylic resin (Rohm & Haas, containing 50% solids=3 g solid wt.), b) 5 mL toluene, c) graphite nanoplatelets as a dried filter cake produced by the method described in Example 4 of U.S. application Ser. No. 12/380,365.

The mixture is processed by a 750 W ultrasonic probe for 30 seconds to 1 minute or until the graphite nanoplatelets appear to be in suspension. Using a 20-mil applicator drawdown bar, a 20-mil polyacrylate thin film is prepared onto test paper (Garner byko-charts, reorder #AG5350). The dry thin film sample is dryed under moderate heat with a heat gun and marked with a laser. A light grey mark on a darker gray background is produced.

### Example 7

In a 2-liter flask, the following are added: a) 36.0 g polystyrene (Mn-260,000), b) 4.0 g Efka-6220 (fatty acid modified polyester), c) 1.5 liters of reagent-grade toluene.

The contents of the flask are stirred until dissolved. A chosen amount of graphite nanoplatelets as a dried filter cake produced by the method described in Example 4 of U.S. application Ser. No. 12/380,365 is added to the flask. With the aid of a 750-watt ultrasonic probe, the toluene/Efka-6220/graphite mixture is processed at 40% intensity for a total of 40 minutes. A pulse method (10 seconds ON-10 seconds OFF) is used to prevent over heating. During sonication a noticeable reduction in particle size is observed and particles become suspended (no settling occurs). 1 liter of toluene is removed by vacuum distillation. The remaining graphite/polystyrene/toluene mixture is poured into a flat-bottom 12″×8″ Pyrex glass dish and oven dried at 60° C. under a low stream of nitrogen overnight. The remaining solid is removed from the Pyrex dish and marked with a laser. A light grey mark on a darker gray background is produced.

### Example 8

For instance, polypropylene/graphite nanoplatelet plaques are prepared as follows. A 50 weight percent concentrate is prepared from graphite nanoplatelets and low molecular weight polyethylene wax (AC617A, Honeywell). The concentrate is prepared by melt mixing or flushing. The concentrate and polypropylene resin (PROFAX 6301, Basell) powders are dry blended to achieve powder mixtures of 2 weight percent graphite based on the composition. The powder mixtures are melt mixed with a DSM micro 15 twin screw extruder (vertical, co-rotating) at 150 rpm for 3 minutes. The melting zone temperature is 200° C. Subsequently, a DSM 10 cc injection molder is used to prepare composite samples in the form of rectangular plaques. The molten mixture is collected in a heated transfer wand and injected at 16 bar into the mold held at 60° C. Upon cooling, the plaques are marked as above.

1. A method for marking a polymer composition comprising a thermoplastic, thermoset, crosslinked or inherently crosslinked polymer which method comprises incorporating into the polymer graphite nanoplatelets having a thickness of about 50 nm or less, a width of about 50 microns or less, a specific density of from about 0.01 to about 0.006 g/cc and an aspect ratio of at least 50, and in a later step exposing a selected portion of the polymer composition to heat from a diode array or laser irradiation to produce markings which are visible under ambient light or UV light.

2. A method according to claim 1 wherein the polymer composition also comprises an organic pigment.

3. A method according to claim 2, wherein the pigment is selected from tetrabenzodiazadiketoperylene, quinacridone, diketopyrrolopyrrole, perylene, indanthrone, anthroquinone, azo, isoindoline and phthalocyanine pigments.

4. A method according to claim 1, wherein exposure to diode array or laser irradiation produces markings which are visible under UV light.

5. A method according to claim 1, wherein exposure to diode array or laser irradiation produces markings which are visible under ambient light.

6. A method according to claim 1, wherein the marking is carried out by exposure to exposure to laser irradiation.

7. A method according to claim 1, wherein the polymer composition is a coating on a substrate.

8. A method according to claim 1, wherein the polymer composition is a plastic article.

9. A method according to claim 1, wherein the thermoplastic, thermoset, crosslinked or inherently crosslinked polymer is selected from polymers of the group, polyolefins, polyamides, polyurethanes, polyacrylates, polyacrylamides, polycarbonates, polystyrenes, polyvinyl acetates, polyvinyl alcohols, polyesters, halogenated vinyl polymers, alkyd resins, epoxy resins, unsaturated polyesters, unsaturated polyamides, polyimides, fluorinated polymers, silicon containing polymers, carbamate polymers and copolymers thereof.

10. A method according to claim 7, wherein the coating comprises a polymer selected from polyurethanes, polyacrylates, polyacrylamides, polyvinyl acetates, polyvinyl alcohols, polyesters, halogenated vinyl polymers, alkyd resins and epoxy resins.

11. A method according to claim 8, wherein the plastic article comprises a plastic substrate selected from polypropylene, polyethylene and polystyrene.

12. A laser marked article prepared according to the method of claim 1.
